(19) United States
(12) Patent Application Publication
(10) Pub. No.: US 2009/0296154 A1
(43) Pub. Date: Dec. 3, 2009

(54) OFF-GRAY BALANCE CALIBRATION FOR EXTENDED COLOR GAMUT

(75) Inventors: Patricia Joanne Donaldson, Pittsford, NY (US); Lalit Keshav Mestha, Fairport, NY (US); Tonya L. Love, Rochester, NY (US); Ta-chen Hsu, San Gabriel, CA (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/466,445

(22) Filed: May 15, 2009

Related U.S. Application Data
(60) Provisional application No. 61/056,346, filed on May 27, 2008.

(51) Int. Cl. H04N 1/40

(52) U.S. Cl. 358/3.01

(57) ABSTRACT

A marking device is provided which is capable of operating in a standard output color gamut mode or a non-standard output color gamut mode. The device includes: a color manager that performs color processing on input color data in accordance with a calibration of the device; and, a marking engine that applied colorants to an image-receiving medium in accordance with output from the color manager. Suitably, when the device is operating in the non-standard mode, then the calibration of the device which is conducted is an off-gray balance calibration.

This application claims the priority benefit of U.S. provisional patent application Ser. No. 61/056,346, filed May 27, 2008, the disclosure of which is incorporated herein by reference.

### TECHNICAL FIELD

The present disclosure generally relates to color management in printing and/or marking systems. In particular, the disclosure is directed to a method and/or system for off-gray balance calibration to improve color stability over time in a printing or marking device in which selectively modified process setpoints are optionally employed to extend an output color gamut of the device beyond its normal or nominal output color gamut, referred to herein as the “standard” output color gamut of the device. While the following disclosure generally makes reference to printers and/or printing, it is to be appreciated that the presently disclosed subject matter is equally applicable to other marking and/or image forming devices, such as copiers or other devices that form images, e.g., on an image-receiving medium.

### BACKGROUND

A typical process color printer or other like marking device commonly uses magenta (M), cyan (C), yellow (Y) and black (K) colorants or color separations in various amounts and/or combinations to achieve a range of colors. Usually, it is deemed desirable for the printer or other marking device to: (i) have a large output color gamut, (ii) be gray-balanced, and (iii) have stable color output over time.

Generally, the output color gamut of a printer can be described by a multi-dimensional space of a given volume with axes of the space being set or defined initially by the pigments, colorants and/or color separations used for the primary colors, e.g., such as M, Y, C and K. Commonly, in forming multi-color output images, for example with a xerographic process, each of the primary colors or colorants (e.g., toner) is deposited on an intermediate image-forming element (e.g., such as a photoreceptor) to develop a latent image thereon prior to being transferred to an image-receiving medium (e.g., such as paper). Any given output color is therefore defined by the interaction of the primary colorants, and the output color gamut of the printer is accordingly limited by a total amount of colorant in any combination that can be effectively deposited and/or transferred. Often, the amount of colorant deposited on the image-forming element is measured in terms of Developed Mass per unit Area (DMA). In this respect, the output color gamut of the printer depends not only upon the pigments used in the colorants, but also upon the total DMA achievable. For example, in a printer employing what is known as Image-On-Image (IOI) processing (e.g., such as the iGen3 digital production presses commercially available from Xerox), the total DMA achievable is generally limited by system interactions, e.g., such that the total DMA developed by all the color separations may be limited to less than approximately 1.2 mg/cm². Notably, the upper limit on DMA in this case is set by various limits imposed as a result of the IOI processing. More generally, the DMA depends on the setpoints for certain process parameters of each of the color separations. These process parameters include, e.g., photoreceptor voltages (charges and/or discharged voltages), donor and/or magnetic roll voltages, toner concentrations, etc.

As stated above, it is commonly desirable for a printer or other marking device to be gray-balanced. One approach to achieving the desired gray-balance is to calibrate the printer to a gray or neutral aim or target curve in color space and generate a tone reproduction curve (TRC) for each of the respective color separations, such that when input digital amounts of the respective color separations are substantially equal to one another (i.e., M=Y=C), then the resulting output has a substantially neutral or gray tint. However, over time, the output of a conventional printer or marking device may drift or otherwise deviate from predetermined optimums due to various factors, e.g., such as environmental conditions (i.e., temperature, relative humidity, etc.), use patterns, the type of media used (e.g., different paper types and paper batches, transparencies, etc.), variations in the media, variations from original models used in initialization of the device, general wear, etc.

Accordingly, to maintain the desired gray-balance and/or corresponding color stability over time, a suitable calibration process is run frequently or as otherwise desired to update the respective gray-balance TRCs. Examples of known gray-balance calibration techniques are disclosed in Mestha, et al., “Gray Balance Control Loop for Digital Color Printing Systems,” published in the proceedings of IS&T's “The 21st International Congress on Digital Printing Technologies (NIP21),” Sep. 18-23, 2005, Baltimore, Md., and U.S. Pat. No. 7,307,752 to Mestha, et al., incorporated by reference herein in their entirety.

Notwithstanding the foregoing, a user may from time-to-time desire to produce an output color which is outside the standard output color gamut available on a given printer or marking device, i.e., as constrained by the colorants/pigments used and/or the current nominal DMA for the device. For example, a user may want to produce an output color having a particular highly saturated hue (e.g., a highly saturated red or other hue) because it is in or part of a corporate logo or other important element of an image to be produced or reproduced. As can be appreciated, this color nevertheless may not be within the standard output color gamut producible by the device as defined by the colorants or pigments employed and the nominal process setpoints, e.g., which constrain the DMA of the device. However, a desired color outside the standard output color gamut of the device may still be achievable, e.g., by altering the DMA of one or more of the colorants (e.g., to produce a highly saturated red by increasing the M and Y DMA). In practice, this can be achieved by allowing a user to modify selected process setpoints, e.g., to shift the output color gamut in a desired direction in color space or otherwise alter the output color gamut from the norm or standard for that device. Methods and/or systems for producing colors outside the normal or standard output color gamut of a device are disclosed, for example, in Mestha, et. al., U.S. patent application Ser. No. 11/099,589, filed Apr. 6, 2005, and Mestha, et al., U.S. patent application entitled “Spot Color Printing With Non-Standard Gamuts Achieved With Process Set Point Adjustment,” filed May 27, 2008, incorporated by reference herein in their entirety.

However, because of system interactions, e.g., in a device employing IOI processing, extending the DMA of one colorant or color separation will generally decrease the DMA of another colorant or color separation, thereby throwing the printer or other marking device out of gray balance. For example, considering a device in which the color separations are processed in MYCK order, the addition of more magenta or extension of the magenta DMA to improve the output red gamut will generally decrease the cyan developed mass, thereby throwing the printer or other marking device out of gray balance, and in accordance with conventional architectures, the desire to maintain gray balance significantly constrains the magenta mass (at least in this example) and thereby limits the output color gamut in the red. Ultimately, some users may be dissatisfied with the resulting red gamut. Of course, in alternate examples where devices process color separations in other orders and/or users desired other particular colors outside the standard output color gamut of a device, similar results and/or dissatisfaction can be experienced.

Nevertheless, as pointed out above, system gray-balance and/or corresponding color stability may be returned in normal fashion by calibrating the printer or other marking device so that input equal digital amounts of the employed color separations (i.e., M=Y=C) gives an output neutral or gray tint. However, trying to perform such gray-balance calibration, while the printer or other marking device is operating or set to operate with modified process setpoints that have been selected to provide for an output color which is outside the normal or nominal output color gamut of the device (i.e., while the output color gamut of the printer or other marking device has been intentionally shifted in a desired direction in color space or otherwise altered from the norm or standard), can introduce certain image quality defects. Accordingly, either gray-balance can be abandoned in shadow regions of an image being produced/reproduced (i.e., regions with densities near solid), which leaves such regions with an off-neutral hue (e.g., with a reddish hue), or the maximum digital area coverage of a particular color separation (e.g., magenta) can be set so that when a user calls for a solid patch of that color separation, then the printer or other marking device employs a halftone. These solutions, however, are not entirely satisfactory. In particular, abandoning gray balance in the shadow regions can lead to other image quality artifacts, e.g., such as contouring, where steps in density are visible in a color gradient sweep. And, halftoning solid patches of a given color separation generally decreases the gamut available, and negatively impacts the benefit achieved by increasing the DMA of the respective color separation in the first place.

Accordingly, a there is disclosed herein a method and/or system which overcomes the above referenced problems and/or others by providing off-gray balance calibration in a printing or marking device in which selectively modified process setpoints are optionally employed to extend an output color gamut of the device beyond its standard output color gamut.

### BRIEF DESCRIPTION

In accordance with one embodiment, a marking device is provided which is capable of operating in a standard output color gamut mode or a non-standard output color gamut mode. The device includes: a color manager that performs color processing on input color data in accordance with a calibration of the device; and, a marking engine that applied colorants to an image-receiving medium in accordance with output from the color manager. Suitably, when the device is operating in the non-standard mode, then the calibration of the device which is conducted is an off-gray balance calibration.

### BRIEF DESCRIPTION OF THE DRAWINGS

FIG. 1 is a box diagram illustrating an exemplary printer or other like marking device suitable for practicing aspects of the presently disclosed subject matter.

### DETAILED DESCRIPTION

Generally, the present specification discloses a method and/or system, for use in connection with a printer or other marking device, in which off-gray balance calibration is performed when the printer or marking device is operating or set to operate in a “non-standard” output color gamut mode (or non-standard-gamut (NSG) mode for short), i.e., where the otherwise normal or nominal output color gamut of the device has been shifted or extended in a desired direction in color space or otherwise altered from the norm of the device (e.g., by modifying or altering selected process setpoints) to allow the device to output one or more particular colors that otherwise would lie outside the standard output color gamut of the device. Conversely, when the printer or marking device is operating or set to operate in a “standard” output color gamut mode (or standard-gamut (SG) mode for short), i.e., where the normal or nominal output color gamut of the device is being employed for the output being produced/reproduced (e.g., by employing the nominal or default process setpoints), then the presently disclosed method and/or system optionally provides for the performance of a conventional gray-balance calibration.

Suitably, the aforementioned NSG mode of operation is optionally implemented in accordance with the teachings of Mestha, et. al., U.S. patent application Ser. No. 11/099,589, filed Apr. 6, 2005, and/or Mestha, et al., U.S. patent application entitled “Spot Color Printing With Non-Standard Gamuts Achieved With Process Set Point Adjustment,” filed May 27, 2008, and the gray-balance calibration is optionally implemented in accordance with the teachings of Mestha, et al., “Gray Balance Control Loop for Digital Color Printing Systems,” published in the proceedings of IS&T's “The 21st International Congress on Digital Printing Technologies (NIP21),” Sep. 18-23, 2005, Baltimore, Md., and/or U.S. Pat. No. 7,307,752 to Mestha, et al.

In one optional embodiment, the off-gray balance calibration is also performed in a similar fashion to the gray-balance calibration. However, in the off-gray balance calibration process, the aim or target colors or aim or target curve employed in the calibration process does not substantially correspond with a gray or neutral tint or gray or neutral axis in the output color space. Rather, the aim or target colors and/or the aim or target curve are selected to have a substantially non-neutral tint or correspond to a substantially off-gray axis. In other words, when the normal gray-balance calibration is performed, the printer or marking device is calibrated to a normal gray-balance axis, i.e., such that when input digital amounts of the respective color separations are substantially equal to one another (i.e., M=Y=C), then the resulting output has a substantially neutral or gray tint. Alternately, when the off-gray balance calibration is performed, the printer or marking device is calibrated to a different substantially off-gray axis, i.e., such that when input digital amounts of the respective color separations are substantially equal to one another (i.e., M=Y=C), then the resulting output has a substantially off-gray or non-neutral tint or hue, e.g., in accordance with the direction in color space in which the otherwise normal or nominal output color gamut of the device has been shifted or extended due to operation of the device in the NSG mode. For example, when the output color gamut of the device is shifted or altered from its standard (e.g., to allow for the production of a normally out-of-gamut red), as may be achieved by selecting process setpoints that result in higher than usual magenta DMA, then the aim curve and/or target colors employed in the off-gray balance calibration process are optionally selected to have a reddish hue. Similarly, if a set of modified process setpoints is used which results in a lower than usual magenta DMA and a higher than usual cyan DMA (e.g., thereby shifting or altering the standard output color gamut of the device to allow for the production of a normally out-of-gamut blue), then the off-gray balance calibration may optionally employ an aim curve and/or target colors which have a blueish hue.

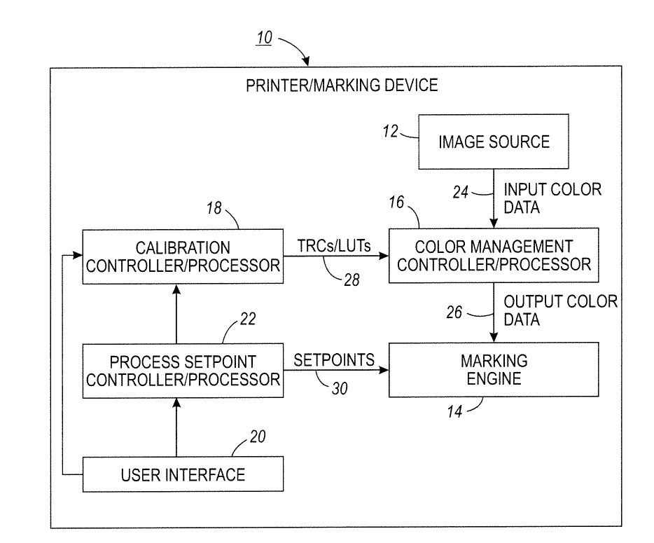

More specifically, with reference to FIG. 1, there is shown a color printer or other like marking device 10 that produces or reproduces a corresponding output color image from input color image data. In suitable embodiments, for example, the device 10 may be a printer, a copier, a facsimile machine, etc. In any event, suitably, the device 10 is a digital color device.

As shown, the device 10 includes an image source 12 from which input image data (e.g., digital image data) is received or otherwise obtained. Suitably, the input image data from the source 12 includes color data and/or values that describe or otherwise define the particular colors of respective elements (e.g., pixels) of an input image. Optionally, the image source 12 may be a scanner that produces input image data from a scanned hardcopy or other like input, a data storage device containing a digital or other image, a digital or other suitable camera (still or video), a locally or remotely located computer or the like which provides the input image data, a facsimile receiver, etc.

In the illustrated embodiment, the device 10 also includes a marking engine 14 or other like image output device. Suitably, the marking engine 14 applies colorants (e.g., toner, ink, etc.) to an image-receiving medium (e.g., paper, transparency, etc.) in accordance with received image data to produce or reproduce an output image corresponding to the input image data. More specifically, the colorants employed by the marking engine 14 to output the respective color image optionally include a plurality of particular pigments and/or color separations, e.g., magenta (M), cyan (C), yellow (Y) and black (K). That is to say, suitably, the marking engine 14 uses various amounts and/or combinations of magenta (M), cyan (C), yellow (Y) and black (K) colorants or color separations to achieve a range of output colors. Accordingly, the standard output color gamut of the device 10 can be in part generally described by a multi-dimensional space of a given volume with axes of the space being set or defined initially by the pigments, colorants and/or color separations used for the primary colors, e.g., such as M, Y, C and K.

Optionally, the marking engine 14 is a xerographic device that employs an intermediate image-forming element (e.g., such as a photoreceptor) onto which a latent image is developed by depositing the colorants thereon prior to the colorants being transferred from the intermediate image-forming element to the image-receiving medium. In particular, the marking engine 14 optionally employs an IOI process whereby the plurality of colorants and/or color separation are deposited and/or developed in overlapping or superimposed fashion on the intermediate image-forming element. Accordingly, any given color produced by the marking engine 14 is therefore defined by the interaction of the primary colorants, and the output color gamut of the device 10 is accordingly limited by a total amount of colorant in any combination that can be effectively deposited and/or transferred.

As shown in FIG. 1, the device 10 also includes a color management controller and/or processor 16 (i.e., color manager (CM) for short). Suitably, the CM 16 parses the input image data and/or otherwise obtains input color data 24 and/or values therefrom and corrects or otherwise adjusts the same (e.g., in accordance with particular TRCs, color look-up-tables (LUTs) and/or other appropriate color transforms) 28 to generate output color data and/or values supplied to the marking engine 14 for production of the output image 26. More specifically, the TRCs and/or LUTs are optionally provided to the CM 16 and/or updated by a calibration controller and/or processor 18 that regulates and/or selectively performs a gray-balance or off-gray balance calibration process for the device 10 depending upon the current operating mode of the device 10, i.e., either SG mode or NSG mode, respectively.

Suitably, the device 10 is also equipped or otherwise provisioned with a user interface (UI) 20 that may be selectively employed by a user to choose an operating mode and/or otherwise control operation of the device 10. For example, via the UI 20, an operator or user may select a particular color rendition dictionary (CRD) from among a plurality of such CRDs provisioned in and/or for the device 10. Each particular CRD is suitably associated with a specific set of particular process setpoints 30 corresponding to process parameters regulating the operation and/or functioning of the marking engine 14. For example, the process setpoints correspond to parameters for the photoreceptor voltage (charged and/or discharged), donor and/or magnetic roll voltages, toner concentrations and the like. Alternately, the UI 20 may allow a user or operator to selectively alter or modify any one or more of the individual process setpoints. In any event, optionally one CRD and/or combination of process setpoints (referred to herein as the standard or default CRD and/or the standard or default process setpoints) corresponds to the SG mode of operation of the device 10. That is to say, when the standard CRD (e.g., the default CRD) is selected or the process setpoints are left in their default or normal state, then the device 10 is set to operate in SG mode, i.e., with the standard output color gamut of the device 10 being available for producing/reproducing an output image. Alternately, when a non-standard or alternate CRD (e.g., different from the default CRD) is selected or the process setpoints are modified or altered from their default or normal state, then the device 10 is set to operate in NSG mode, i.e., with an output color gamut being available that is shifted or extended in a desired direction in color space or otherwise altered from the standard output color gamut, e.g., to allow production of a color in the output image which would otherwise normally reside outside of the standard output color gamut of the device 10.

Suitably, as shown in FIG. 1, a process setpoint controller and/or processor 22 sets and/or provides selected process setpoints to the marking engine 14 which in turn operates and/or functions in accordance therewith. In this manner, by selectively setting, modifying and/or otherwise providing selected process setpoints to the marking engine 14, the process setpoint controller/processor 22 is able to achieve a selective shift or extension or other alteration of the output color gamut of the device 10 from the standard output color gamut. For example, since the output color gamut of the device 10 depends at least partially upon the DMA of the respective color separations which in turn can be altered by changing the process setpoints, the setpoint controller/processor 22 is capable of selectively altering the output color gamut of the device 10. Optionally, the setpoint controller/processor 22 selects or otherwise selectively modifies particular process setpoints that are provided to the marking engine 14 in accordance with the CRD selected via the UI 20 and/or in accordance with particular setpoint values selected via the UI 20. Alternately, the process setpoints are selected and/or modified based upon other control input received by the setpoint controller/processor 22.

In one exemplary embodiment, the calibration controller/processor 18 controls and/or performs a calibration process for the device 10. Suitably, either a gray-balance or off-gray balance calibration is selected by the calibration controller/processor 18 depending on the operational mode of the device 10. In particular, if the device 10 is operating in the SG mode (i.e., if the default or standard CRD has been selected or the process setpoints are set to their default or standard or normal values (e.g., via appropriate manipulation of the UI 20 or otherwise) or if the device 10 is otherwise set to operate using its standard output color gamut), then a conventional gray-balance calibration is selected, and in turn performed at the appropriate time. Alternately, if the device 10 is operating in the NSG mode (i.e., if an alternate CRD (e.g., different from the standard or default CRD) has been selected or the process setpoints are modified or altered from the default or standard or normal values (e.g., via appropriate manipulation of the UI 20 or otherwise) or if the device 10 is otherwise set to operate using an output color gamut that has been shifted or extended in a desired direction in color space or which has otherwise been altered from the standard or norm (e.g., to allow for the output production of one or more specific colors which would otherwise normally lie outside the standard output color gamut of the device 10)), then an off-gray balance calibration is selected, and in turn performed at the appropriate time.

Optionally, the calibration controller/processor 18 determines or recognizes the operational state of the device 10 based upon input or other indications of the same received or obtained by the calibration controller/processor 18, e.g., from either or both the UI 20 and/or the process setpoint controller/processor 22. For example, the particular mode, CRD and/or process setpoint selections (e.g., entered via the UI 20 or otherwise established) are optionally communicated to the calibration controller/processor 18, and based thereon the calibration controller/processor 18 can: (i) determine the type of calibration to select and/or perform (i.e., either gray-balance calibration or off-gray balance calibration), and/or (ii) optionally further regulate the calibration process—i.e., in accordance with and/or depending upon the recognized operational mode (e.g., NSG or SG) and/or the selected process setpoint parameters and/or the otherwise established output color gamut (e.g., the standard output color gamut or a shifted or extended or otherwise altered or modified output color gamut). Alternately, the various process setpoint values may be communicated from the process setpoint controller/processor 22 to the calibration controller/processor 18. In any event, upon selecting and completing the appropriate calibration process, TRCs, color LUTs and/or other like suitable transforms are generated and/or updated in accordance therewith. In turn the generated TRCs, color LUTs and/or other transforms or corresponding updates thereto are provided to the CM 16 that performs color corrections, adjustments and/or other appropriate color processing using the provided and/or updated TRCs, color LUTs and/or other transforms.

More specifically, when gray-balance calibration is called for, the TRCs, color LUTs and/or other transforms are generated or updated so that when digital input color values or data (e.g., received by the CM 16) are defined or can be represented by substantially equal amounts of the respective color separations (i.e., M=Y=C), then the resulting output has a substantially neutral or gray tint. Suitably, the gray-balance calibration is optionally implemented in accordance with the teachings of Mestha, et al., “Gray Balance Control Loop for Digital Color Printing Systems,” published in the proceedings of IS&T's “The 21st International Congress on Digital Printing Technologies (NIP21),” Sep. 18-23, 2005, Baltimore, Md., and/or U.S. Pat. No. 7,307,752 to Mestha, et al.

Alternately, when off-gray balance calibration is called for, the TRCs, color LUTs and/or other transforms are generated or updated so that when digital input color values or data (e.g., received by the CM 16) are defined or can be represented by substantially equal amounts of the respective color separations (i.e., M=Y=C), then the resulting output has a particular non-neutral or off-gray tint. Optionally, the off-gray balance calibration is achieved by altering the target colors or aim curve in the calibration process from neutral colors or a gray axis in color space (e.g., as would be used in gray-balance calibration) to specific non-neutral colors and/or a particular off-gray axis in color space. For example, when the output color gamut of the device is shifted or altered from its standard (e.g., to allow for the production of a normally out-of-gamut red), as may be achieved by selecting process setpoints that result in higher than usual magenta DMA, then the aim curve and/or target colors employed in the off-gray balance calibration process are optionally selected to have a reddish hue. Similarly, if a set of modified process setpoints is used which results in a lower than usual magenta DMA and a higher than usual cyan DMA (e.g., thereby shifting or altering the standard output color gamut of the device to allow for the production of a normally out-of-gamut blue), then the off-gray balance calibration may optionally employ an aim curve and/or target colors which have a bluish hue. Otherwise, the off-gray balance calibration may be executed and/or implemented in substantially the same manner as the gray-balance calibration.

In one suitable embodiment, where the input color data is defined in terms of device independent parameters, such as L*a*b* values, optionally, the CM 16 employs color LUTs or other suitable transforms (e.g., generated and/or updated by the performed calibration process) that map the L*a*b* values to appropriate CMYK quantities to provide the desired output color in accordance with the executed calibration. Alternately, where the input color data is defined in terms CMYK values, optionally, the CM 16 employs 4-4 CMYK to CMYK transforms (e.g., generated and/or updated by the performed calibration process) that map input CMYK values to appropriate output CMYK quantities to provide the desired output color in accordance with the executed calibration.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A marking device which transforms a source image and an input set of instructions into a output color gamut, said device comprising:
a user interface;
a process setpoint controller computer processor;
a calibration controller computer processor which receives data from the process setpoint controller and produces at least one of: a tone reproduction curve and a look up table;
an image source that receives an image and produces color data;
a color management controller computer processor that receives input color data from the image source and performs color processing on the received data in accordance with tone reproduction curves and look up tables received from the calibration control processor and outputs color data; and,
a marking engine that receives color data from the color management controller processor and receives setpoints from the process setpoint controller processor in order to determine the amount of colorant applied to a print surface.

2. The marking device of claim 1, wherein the user interface performs at least one of received text data, parses text data, selects an operating mode, controls the operation of the marking device, selects a color rendition dictionary, and alters or modifies setpoints.

3. The marking device of claim 1, wherein the process setpoint controller generates setpoints.

4. The marking device of claim 3, wherein the setpoint comprises a process parameter which regulates the operations functioning of the marking engine.

5. The setpoints of claim 4, wherein the setpoint parameters further comprise photoreceptor voltages, toner concentrations, donor voltages and magnetic voltages.

6. The marking device of claim 1, wherein the color processing performed by the color management controller computer processor adjusts and corrects input image data in accordance with the tone reproduction curve and color lookup tables to generate output color data values to the marking engine.

7. The marking device of claim 1, wherein the image source comprises at least one of color data values, pixels, scanner image data, digital camera or video data, and fax data.

8. The marking device of claim 1, wherein the color management controller comprises an intermediate image framing photoreceptor element upon which colorants are deposited upon prior to printing.

9. The marking device of claim 1, wherein the marking engine applies colorants to an image receiving medium in accordance with the received image data.

10. The marking device of claim 9, wherein the colorants comprise toner and ink comprising any combination of magenta, cyan, yellow, and black.

11. The marking device of claim 1, wherein if the setpoints are altered to operate in a non-standard mode, then the calibration of the device is conducted using an off-gray balance calibration.

12. The marking device of claim 11, wherein the non-standard mode comprises shifting the printing gamut to output colors outside the standard gamut mode.

13. A method of transforming a source image into a corrected printed image, comprising the steps of:
inputting an image received from an image source;
parsing input image into color input image data through use of a computer processor;
choosing an operating mode through use of a user interface;
processing a plurality of setpoints;
calibrating a tone reproduction curve and a color lookup table based on the operating mode selection;
adjusting the color input data using the tone reproduction curve and the color lookup table to produce output color data;
generating corrected color output data based on the color output data and the setpoints;
applying an image produced using the corrected color output data onto an intermediate image forming element; and
depositing colorants onto a printing surface based on the one intermediate image forming elements.

14. The marking method of claim 13, wherein the input source is at least one of a scanner, a photographic camera, a video camera, a computer, or a fax machine.

15. The marking method of claim 13, wherein the operating mode is a conventional gray-balance calibration such that the resulting color has a neutral tint.

16. The marking method of claim 13, wherein the operating mode is an off-gray balance calibration such that the output has a non-neutral tint.

17. The marking method of claim 13, wherein the intermediate image forming element comprises a plurality of overlapping and superimposed elements.

18. A marking system comprising,
a user interface;
a process setpoint controller computer processor which produces setpoints;
a calibration controller computer processor that produces at least one of a tone reproduction curve and a look up table;
an image source that produces color data;
a color management controller computer processor that performs color processing in accordance with tone reproduction curves and look up tables received from the calibration control processor and outputs color data; and,
a marking engine that determines the amount of colorant applied to a print surface.

19. The marking system of claim 18, wherein the color management controller comprises an intermediate image framing photoreceptor element upon which colorants are deposited upon prior to printing.

20. The marking system of claim 18, wherein setpoints comprise process parameters which regulate the operations functioning of the marking engine parameters, wherein the parameters include at least one of photoreceptor voltages, toner concentrations, donor voltages and magnetic voltages.
